(19) United States
(12) Patent Application Publication
(10) Pub. No.: US 2020/0316678 A1
(43) Pub. Date: Oct. 8, 2020

(54) GAS PURGING DEVICE

(71) Applicant: Refractory Intellectual Property GmbH & Co. KG, Wien (AT)

(72) Inventors: Marcos Tomás Casado, Weiz (AT); Bianca Brosz, Trumau (AT); Michael Freiler, Wr. Neustadt (AT); Michael Klikovich, Hinterbrühl (AT); Roman Kulp, Wien (AT)

(21) Appl. No.: 16/088,438

(22) PCT Filed: May 3, 2016
(86) PCT No.: PCT/EP2016/059833

§ 371 Date: Sep. 25, 2018

(51) Int. Cl. B22D 1/00; B22D 11/117; F27D 3/16

(52) U.S. Cl. CPC B22D 1/005; F27D 3/16; B22D 11/117

(57) ABSTRACT

The invention relates to a gas purging device for installation in a metallurgical vessel, said device having the following features in a position installed in the bottom of the metallurgical vessel:
a lower, largely gas-tight base part,
a gas line runs in the base part from a first end in the region of a first outer face of the base part to a second end in the region of a second outer face of the base part,
the second end of the gas line is formed as a first portion of a coupling,
a second portion of a coupling is located in the region of an outer connection face of a functional part, by means of which the functional part rests against the base part,
a gas distribution device runs in the functional part from the second portion of the coupling, through the functional part, to at least one free surface of the functional part formed as a gas outlet face,
the base part and functional part are each made of a refractory ceramic material.

The invention relates to a gas purging device for installation in a metallurgical vessel.

Gas purging devices of the generic kind are used to blow gases or gas/solid mixtures into a melt that is to be processed, in particular a metallurgical melt, which is processed in what is known as a metallurgical vessel. For example, the metallurgical vessel can be what is known as a ladle or in particular what is known as a tundish.

Gas purging elements with what is known as directed porosity, in which case the gas is guided along channels/slits, and also gas purging elements with what is known as non-directed porosity (or random porosity), in which case the gas flows through an irregular open pore volume (similar to that of a sponge) are known.

Gas purging devices of this kind (gas purging elements, gas purging bricks) can be arranged in or on a metallurgical vessel in different ways, for example in the bottom or in the wall of the vessel.

The invention above all relates to a gas purging device which is placed in the bottom region of a tundish. The tundish itself has a bottom and walls, which each have, on their inner side, a refractory lining/coating.

Document U.S. Pat. No. 5,054,749 A discloses a tundish having what is known as a permanent refractory lining. A hollow chamber is arranged in the permanent refractory lining of the bottom and a gas line opens out into said hollow chamber. The hollow chamber is delimited upwardly towards the melt by a gas-permeable plate. The gas conducted into the hollow chamber is conducted into the metal melt via the gas-permeable plate. This arrangement has a number of disadvantages: there is a high risk of infiltration of the metal melt into the hollow chamber through the plate; the plate can easily break under the ferrostatic pressure of the melt.

The same is true for the gas purging device according to U.S. Pat. No. 5,219,514 A.

According to U.S. Pat. No. 4,243,210 refractory gas purging elements having different gas permeability are installed in the bottom of a tundish. The device consists of a number of parts, which all have to be replaced when they become worn.

The object of the invention is to provide a gas purging device of the aforementioned kind which has a high safety standard and when worn can be easily replaced.

In order to solve this problem, the invention proceeds on the basis of the following considerations:

In any case, a processing gas has to be guided to the wall or bottom region of the metallurgical vessel. This part, similarly to the permanent refractory lining of the metallurgical vessel, can be formed by a base part of the gas purging device which can be gas-tight with the exception of the gas line (since it is used only to feed gas and not to distribute gas). This base part consists of refractory ceramic material and has a high resistance to wear, such that it seldom has to be replaced, if at all.

By contrast, a functional part is provided for the distribution of the gas in the metal melt and preferably can be easily installed and easily replaced, because it is a wearing part. The wear is caused on account of the gas distribution in the functional part and also by metallurgical attacks, in particular corrosion and abrasion by the metal melt.

This functional part is at least partially gas-permeable, that is to say it has gas-permeable portions. The gas that flows in via the gas line in the base part should be guided into the metal melt through the gas-permeable portions.

The invention provides a fluidic connection (gas connection) in the region of transition from the base part to the functional part, that is to say a kind of coupling, wherein the connection/coupling should be releasable.

The coupling comprises at least two portions, specifically a first portion at the gas outlet-side end of the gas line at the base part and a second portion, which is arranged on the functional part.

In this way, the functional part can be connected to the base part by fitting (sliding, clipping) the functional part onto the base part. In so doing, the portions of the coupling are connected fluidically to one another, and a continuous gas flow from the gas line in the base part, via the coupling, to one or more gas outlet faces at the functional part is possible.

In other words: the gas purging device is formed in at least two parts. The base part takes on the task of feeding gas to the functional part. The base part can remain in the metallurgical vessel. The base part can be placed such that it does not come into contact with the metal melt. The gas line in the base part, via which the gas is fed, can also remain permanently in the metallurgical vessel and does not have to be replaced (or at least only has to be replaced much less frequently than the functional part).

The base part can therefore be arranged in the bottom of the metallurgical vessel such that the surface of said base part is more or less flush with the refractory bottom of the metallurgical vessel. The base part, however, can also protrude beyond the bottom of the vessel. The functional part is then placed on the base part (embodiments for this will be described hereinafter), more specifically such that the coupling portions of the base part and functional part allow a fluidic connection for the gas from the base part into the functional part.

The geometry of the base part and functional part is preferably such that both parts of the gas purging device supplement one another in a form-fitting manner.

The functional part can be positioned on the base part already via the coupling. In order to prevent the functional part from releasing from the base part, it is expedient to additionally mechanically secure the functional part and base part. If the functional part extends between opposite walls of the metallurgical vessel, this can be implemented in that the refractory walls of the metallurgical vessel cover the two end portions of the functional part. Alternatively, a fixing can be provided via additional (separate) refractory components (for example: wedges).

In contrast to the known gas purging devices according to the prior art, which are all static, a wearing part (the functional part) can be regularly renewed in accordance with the invention, whereas the base part can be used over a much longer cycle and is therefore fixedly installed in the metallurgical vessel. This is true similarly for the gas line running through the base part.

In its most general embodiment, the invention relates to a gas purging device for installation in a metallurgical vessel, said device having the following features in a position installed in the bottom of the metallurgical vessel:
a lower, largely gas-tight base part,
a gas line runs in the base part from a first end in the region of a first outer face of the base part to a second end in the region of a second outer face of the base part,
the second end of the gas line is formed as a first portion of a coupling,
a second portion of a coupling is located in the region of an outer connection face of a functional part, by means of which the functional part rests against the base part,
a gas distribution device runs in the functional part from the second portion of the coupling, through the functional part, to at least one free surface of the functional part formed as a gas outlet face,
the base part and functional part are each made of refractory ceramic material (of the same or different type).

The gas line can be either a separate pipeline, which runs in the refractory material of the base part, or the gas line can alternatively also be formed in situ in the refractory material of the base part.

The first end of the gas line is connected to a gas feed, and the second end of the gas line is connected to the coupling. The coupling comprises at least two portions, but can also be formed in a greater number of parts. In any case, a portion of the coupling is part of the base part and a portion of the coupling is part of the functional part.

The coupling has a number of functions: it is used primarily to create a fluidic connection for the gas from the base part into the functional part. However, it is also used as an adjustment device when connecting the functional part and base part. For this purpose, a coupling part can protrude beyond the associated component (base part, functional part), whereas the corresponding coupling portion is formed by an indentation in a surface of the other component (functional part, base part). This leads consequently to a tongue and groove connection between the base part and functional part by means of a male part and a female part. A form-fit joint makes it possible to avoid gas diffusions and to lead the gas along the desired path.

The first portion of the coupling for example protrudes beyond the second outer face of the base part, and the second portion of the coupling is formed by a corresponding indentation in the connection face of the functional part.

Here, the second outer face of the base part can be an upper face of the base part, and the outer connection face of the functional part can be a lower face of the functional part. In the functional position of the device, both faces preferably run horizontally. In this case, the functional part can be placed (fitted) onto the base apart from above.

As already disclosed above, it is advantageous if the second outer face of the base part and the outer connection face of the functional part supplement one another in a form-fitting manner in the installed position.

In the simplest case, a form fit is provided already when the second outer face of the base part and the outer connection face of the functional part are each planar (with the exception of the points where the coupling portions are arranged).

The base part and functional part can be designed such that a vertical cross-section presents one of the following geometries: rectangle, square, trapezium, triangle, polygon, segment of a circle, U-shape, L-shape. Other geometries of the base part and functional part which supplement one another in a form-fitting manner are also possible.

Accordingly, the following geometries for example is provided for the base part and/or the functional part, considered three-dimensionally: cuboid, square-beam, half-cylinder, L-profile, U-profile, etc.

The gas distribution device in the functional part are essential for the gas distribution in the metallurgical vessel. The objective is to conduct the gas from the coupling to one or more surfaces (portions) of the functional part before it flows into the metal melt.

For this purpose, a gas channel can firstly lead from the coupling to a gas distribution chamber within the functional part. Gas-permeable zones of the functional part run from this gas distribution chamber to the surface portions of the functional part via which the gas flows from the functional part into the metal melt. These zones can be formed with non-directed porosity and/or directed porosity.

With an arrangement of the gas purging device in the bottom of the metallurgical vessel (tundish), it follows that the gas-permeable zones of the functional part run in particular “above the gas distribution chamber”, although gas-permeable zones arranged laterally beside the gas distribution chamber are also possible.

Conversely, it is expedient to form a “lower region of the functional part” in a gas-tight manner, i.e. in particular a region of the functional part adjacent to the base part and/or horizontally laterally beside the coupling, so that the gas can be guided selectively in the direction of the gas-permeable zones. The gas-permeable zone(s) in the functional part can be formed in situ or as separate inserts.

It is sufficient if the functional part, beside to the gas distribution chamber, has a zone that wholly or partially has a non-directed and/or directed open porosity. It is also possible to arrange a plurality of zones that are fluidically connected or are independent of one another.

It is clear from the above that the gas distribution chamber is adapted in terms of its size and shape so as to create the most advantageous possible contact face relative to the gas-permeable zones of the functional part.

In accordance with one embodiment, the gas line runs in the base part horizontally (to the greatest possible extent) from a first end in the region of a vertical lateral outer face of the base part, through the base part, and then in a manner rising to the first portion of the coupling. Here, the gas line in the base part can have a spiralled portion, which forms a kind of penetration guard against any infiltrating metal melt, which can quickly solidify (freeze) in the region of the spiralled portion.

The coupling can be arranged at any arbitrary point of the base part or functional part. An additional safeguarding function for preventing incorrect assembly of the base part and functional part is created by an eccentric arrangement. The functional part can be rotatable relative to the base part, wherein the coupling functions as a swivel joint.

In addition, it is possible to firstly connect the coupling portions and to then pivot the (movable) functional part relative to the (fixedly installed) base part. The plane of rotation runs here perpendicularly to the direction of flow of the gas through the coupling. This results in the additional possibility of adapting the geometry of the base part and the functional part such that corresponding protrusions and recesses on the base part and functional part are brought into a mutually latching position, which hinders an unintentional release of the functional part from the base part. This is true in particular for the U- or L-shapes, already mentioned above, of the base part and functional part, which will also be explained in the description of the drawings below.

The coupling does not have to ensure absolute gas tightness. Nevertheless, a gas-tight connection, for example with the aid of seals, is expedient in order to guide the gas selectively to the porous (gas-permeable) zones of the functional part.

The coupling portions can be separate component parts which are secured to the base part and functional part; the coupling portions can also be shaped in situ on or in the refractory material of the base part and functional part.

There are no limitations for the selection of the refractory material. Said material can be selected depending on the application.

Further features of the invention will become clear from the features of the dependent claims and the other application documents.

The invention will be explained in greater detail hereinafter with reference to various exemplary embodiments.

The drawings show the following, in each case in a schematic depiction:

FIG. 1: a vertical longitudinal section through a base part;

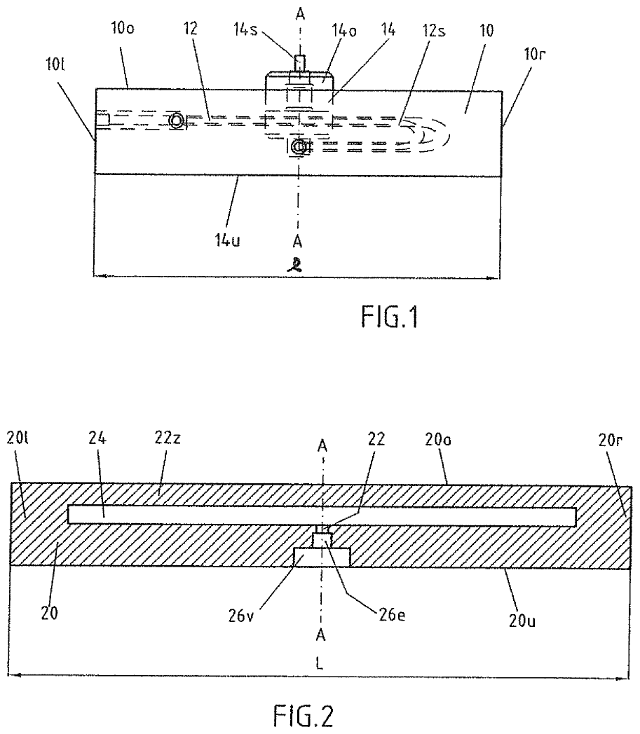

FIG. 2: a vertical longitudinal section through a functional part which can be connected to the base part according to FIG. 1;

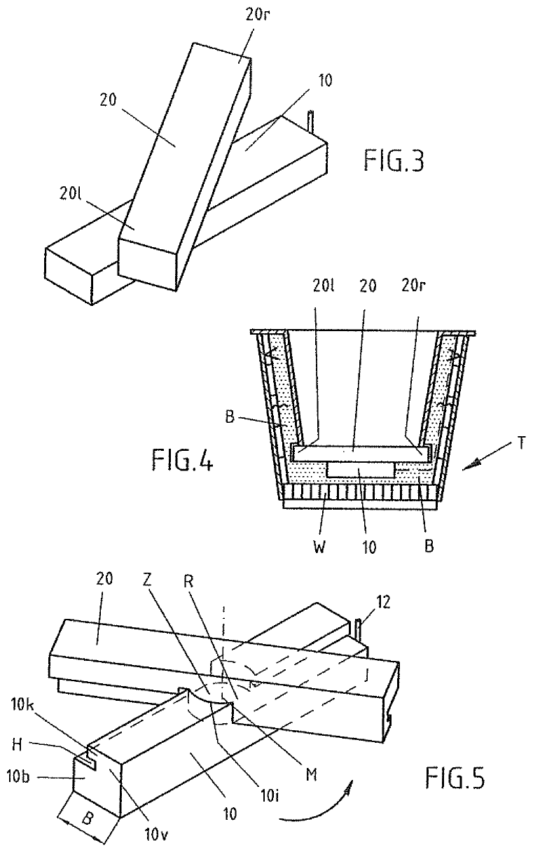

FIG. 3: a gas purging device formed of a base part and functional part according to FIGS. 1 and 2 when installed, in a perspective view;

FIG. 4: the gas purging device according to FIG. 3 in an installed/functional position in a tundish;

FIG. 5: a depiction according to FIG. 3 for a further embodiment of a gas purging device.

Like or equivalent components are depicted in the drawings by like reference signs.

FIG. 1 shows a base part 10 made of refractory ceramic material in the form of a square-beam (FIG. 3), that is to say in the form of an elongate cuboid having six outer faces running at right angles to one another, of which a first outer face 101 (small end face on the left) and an upper (large) end face 10o are referenced in FIG. 1.

A gas line 12 made of metal runs from a first end in the region of the side face 101 approximately horizontally into the base part 10 and then has a spiralled portion 12s, which opens out into a lower end 14o of a first coupling portion 14, which is secured as a separate metallic component in a corresponding indentation in the base part 10. The upper end 14o protrudes beyond the upper end face 10o of the base part 10, wherein the protruding part 14o of the coupling portion 14 is cylindrical and has a gas outlet connection nozzle 14s, which protrudes freely upwardly.

FIG. 2 shows an associated functional part 20, again in the form of an elongate cube (FIG. 3), wherein the functional part 20 is longer in the longitudinal direction (horizontal direction) (length L) than the base part 10 (length 1).

The functional part 20 has a lower connection face 20u, in which a circular indentation 26v is formed centrally (in the longitudinal direction L), said indentation being formed by a pocket-shaped metal part.

The indentation 26v has an extension 26e upwardly, but with a smaller diameter. The extension 26e consists of a metal sleeve. The indentation 26v and extension 26e form a second coupling portion 26. They can alternatively also be formed in situ in the refractory material of the functional part 20.

The extension 26e and indentation 26v are designed with regard to their dimensions such that the first coupling portion 14 (upper portion 14o, connection piece 14s) of the base part fits flush (gas-tight) in the second coupling part 26 (indentation 26v, extension 26e) on the functional part 20 when the functional part 20 is placed via its underside 20u on the upper side 10o of the base part 10 (FIG. 3).

In order to improve the gas tightness, a seal, for example a refractory graphite seal, can be inserted between the connection piece 14s and the inner wall of the extension 20e.

A bore 22 extends vertically upwardly from the extension 26e to a gas distribution chamber 24 running horizontally in the functional part 20.

The refractory material beneath the gas distribution chamber and laterally beside the gas distribution chamber 24 is gas-tight to the greatest possible extent. The zone 22z of the refractory material running above the gas distribution chamber 24 is gas-permeable and is formed with non-directed (open) porosity. The upper free end face 20o of the functional part is the face that rests against a metal melt in the functional position of the device. A gas is delivered into the melt via the face 20o.

The base part 10 and functional part 20, as shown in FIG. 3, are assembled by placing the functional part 20 on the base part. The base part can already have been firmly anchored beforehand in the metallurgical vessel (FIG. 4). The functional part 20 is placed on the base part 10 such that the indentation 26v and the extension 26e (which form the second portion 26 of the coupling) are placed in a form-fitting manner on the upper portion 14o and the connection piece 14s (which form the first portion 14 of the coupling).

Due to the arrangement of the coupling portions, the functional part 20 can then be brought into the functional position, in which the functional part 20 is aligned with the base part 10 (FIG. 4), by horizontally rotating the functional part 20 about an axis A-A, which runs centrally and vertically through the coupling portions.

The base part 10 is installed in the bottom B of the metallurgical vessel (tundish T in FIG. 4), and the gas line 12 is connected to a gas supply. The functional part 20 is then placed in position, as described above.

The functional part 20 is fixed in the metallurgical vessel, as depicted in FIG. 4, by applying a refractory lining W to the walls of the metallurgical vessel (T) in such a way that it covers end portions 201, 20r of the functional part 20. A release of the functional part 20 from the base part 10 during operation as soon gas is delivered via the gas line 12, through the coupling (14, 26) and the gas distribution chamber 24 and the porous zone 22z and the surface 20o, into an associated metal melt is thus avoided.

The embodiment according to FIG. 5 differs from the embodiment according to FIGS. 1 to 4 merely by the specific geometric shape of the base part and functional part 20.

The base part 10 and functional part 20 are again beam-shaped.

An L-shaped part is cut away on the base part 10 at an end portion (in the longitudinal direction of the base part), such that a U-shape of the base part 10 is produced in a side view, wherein one limb of the U 10k is shorter and narrower than the other limb of the U 10b, with a connection portion 10v therebetween. The end portion ends at a distance from the middle (M) of the base part.

The other end portion (on the right in the drawing) is shaped similarly, but in a mirrored manner with respect to a plane running vertically through the base part with B/2, wherein B is the width of the base part 10.

A cylindrical space R is formed between the two U-shaped end portions, into which space a cylindrical pin Z protrudes, said pin being part of the functional part 20 and being formed between end portions of the functional part 20.

The end portions of the functional part 20 are each formed in a manner corresponding to the end portions of the base part 10, such that a form fit is produced when the functional part 20 is firstly placed via its coupling part (not depicted) on the coupling part (not depicted) of the base part 10 and the functional part is then rotated horizontally in an anticlockwise direction (arrow). The coupling parts are formed similarly to those of the first exemplary embodiment. The finished assembled position corresponds to that according to the first exemplary embodiment.

As a result of the recesses H formed by the shorter limb 10k, the connecting web 10v, and the wider limb 10b, a mechanical fixing of the functional part 20 to the base part 10 is achieved when the corresponding limbs of the functional part are introduced into the corresponding recesses H of the base part.

1. A gas purging device for installation in a metallurgical vessel, comprising the following features in its installed position:
a) a lower, gas-tight base part (10),
b) a gas line (12) runs in the base part (10) from a first end in the region of a first outer face (101) of the base part (10) to a second end in the region of a second outer face (10o) of the base part (10),
c) the second end of the gas line (12) is formed as a first portion (14) of a coupling,
d) a second portion (26) of the coupling is located in the region of an outer connection face (20u) of a functional part (20), by means of which the functional part (20) rests against the base part (10),
e) a gas distribution device (24) runs in the functional part (20) from the second portion (26) of the coupling, through the functional part (20), to at least one free surface (20o) of the functional part (20) formed as a gas outlet face,
f) the base part (10) and functional part (20) are made of refractory ceramic materials.

2. The gas purging device according to claim 1, the first and second portions (14, 26) of the coupling of which are formed as corresponding portions in a form-fitting manner.

3. The gas purging device according to claim 1, in which the first portion (14) of the coupling protrudes beyond the second outer face (10o) of the base part (10) and the second portion (26) of the coupling is formed by a corresponding indentation (26v) in the connection face (20u) of the functional part (20).

4. The gas purging device according to claim 1, in which the second outer face (10o) of the base part (10) is an upper face of the base part (10) and the outer connection face (20u) of the functional part (20) is a lower face of the functional part (20).

5. The gas purging device according to claim 1, in which the second outer face (10o) of the base part (10) and the outer connection face (20u) of the functional part (20) run relative one another in a form-fitting manner.

6. The gas purging device according to claim 1, in which the second outer face (10o) of the base part (10) and the outer connection face (20u) of the functional part (20) are planar faces.

7. The gas purging device according to claim 1, in which the base part (10) and the functional part (20) in a vertical cross-section have one of the following geometries: rectangle, square, trapezium, triangle, polygon, segment of a circle, U-shape, L-shape.

8. The gas purging device according to claim 1, in which the functional part (20) adjacently to the gas outlet face (20o) has a zone (22z) that wholly or partially has a non-directed open porosity.

9. The gas purging device according to claim 1, in which the functional part (20) adjacently to the gas outlet face (20o) has a zone (22z) that wholly or partially has a directed open porosity.

10. The gas purging device according to claim 1, in which the gas line (12) runs largely horizontally in the base part (10) from a first end in the region of a vertical lateral outer face (10r) of the base part (10), through the base part (10), and then in a manner rising to the first portion (14) of the coupling.

11. The gas purging device according to claim 1, in which the gas line (12) has a spiralled portion in the base part.

12. The gas purging device according to claim 1, in which the portions (14, 26) of the coupling are arranged centrally in the direction of a longitudinal axis (L) of the device.

13. The gas purging device according to claim 1, in which the portions (14, 26) of the coupling can be connected to one another in a gas-tight manner.

14. The gas purging device according to claim 1, in which the portions (14, 26) of the coupling are formed by separate components (14o, 14s; 26v, 26e) which are fastened to the base part (10) and to the functional part (20).

15. The gas purging device according to claim 1, in which the functional part (20) is rotatable relative to the base part (10), wherein the coupling has the function of a swivel joint.
